(19) United States
(12) Patent Application Publication
(10) Pub. No.: US 2025/0305987 A1
(43) Pub. Date: Oct. 2, 2025

(54) Method And System For Non-Contact Rail Inspection For Using A Hybrid Emat, Mfl And Miec Transducer Excited Using Laser Generated Ultrasound

(71) Applicant: Board of Trustees of Michigan State University, East Lansing, MI (US)

(72) Inventors: Yiming Deng, Okemos, MI (US); Sunil Chakrapani, Okemos, MI (US); Ming Han, Okemos, MI (US); Zebadiah Miles, Lansing, MI (US)

(21) Appl. No.: 19/092,496

(22) Filed: Mar. 27, 2025

Related U.S. Application Data
(60) Provisional application No. 63/571,542, filed on Mar. 29, 2024.

(51) Int. Cl. G01N 27/90; G01N 27/9013; G01N 27/904; G01N 27/9093; G01N 29/24; G01N 29/265; G01N 29/44

(52) U.S. Cl. CPC G01N 27/9006; G01N 27/902; G01N 27/904; G01N 27/9093; G01N 29/2418; G01N 29/265; G01N 29/4445; G01N 2291/2623

(57) ABSTRACT

A rail inspection system and probe include a moving carrier having a direction of motion. The probe includes a magnetic circuit having a first leg comprising a first end and a second end, a second leg spaced-apart from the first leg, the second leg comprising a first end and a second end, and a yoke magnetically coupling the second end of the first leg and the second end of the second leg. The magnetic circuit generates a magnetic field aligned with the direction of motion, and at a center point between the first leg and the second leg no motion-induced current is present under defect free conditions of the rail. A circuit board extends between the first leg and the second leg. A plurality of magnetic sensors is disposed proximate the center point.

### CROSS-REFERENCE TO RELATED APPLICATION

This application claims the benefit of U.S. Provisional Application No. 63/571,542, filed on Mar. 29, 2024. The entire disclosure of the above application is incorporated herein by reference.

### FIELD

The present disclosure relates to rail inspection for rail transportation and, more specifically to rail inspection using a hybrid electromagnetic acoustic transducer (EMAT) system, magnetic flu leakage (MFL) system and motion-induced eddy current (MIEC) system.

### BACKGROUND

This section provides background information related to the present disclosure which is not necessarily prior art.

Rail transportation is a critical mode of transporting people and goods globally. Despite its importance, the sector is periodically marred by accidents, highlighting ongoing safety challenges. In the USA alone, approximately 2,000 railway accidents occur annually, resulting in substantial economic losses estimated at $300 million. This underscores the urgent need for effective rail inspection methods. Current Nondestructive Evaluation (NDE) techniques, including ultrasonic testing (UT), electro-magnetic acoustic transducer (EMAT), magnetic flux leakage (MFL), eddy current testing (ECT), and vision inspection systems (VIS), are hindered by limitations such as low detection accuracy and sensitivity, particularly at high speeds.

### SUMMARY

This section provides a general summary of the disclosure and is not a comprehensive disclosure of its full scope or all of its features.

The present disclosure introduces a novel MIEC method for high-speed, high-accuracy rail inspection. The MIEC method employs an electromagnet to generate motion-induced eddy currents in the rail track, adhering to Maxwell's equations. This technique promises higher Signal-to-Noise Ratios (SNR) and sensitivity, capable of detecting defects at speeds up to 60 mph.

One aspect of the system and method is the alignment of the magnetic field with the direction of motion, which enables zero motion-induced current at the center under defect-free conditions. A self-nulling probe simplifies analysis and reduces bias in signal processing. Additionally, the use of a sensor array, as opposed to a single sensor, allows for adapting to different velocities, maintaining a null signal under defect-free conditions. Simulation studies validate the efficacy of the MIEC method. Results indicate a direct correlation between speed and the density of MIEC, with higher velocities enhancing the amplitude of MIEC defect signals. This translates to superior inspection capabilities compared to existing methods.

Laser induced ultrasonics are used. In addition, the MIEC in high speed operation and MFL in low speed or no speed operation (below a predetermined speed threshold) are used together. MEIC and MFL can use the same magnetic field detection sensors a such as all Hall effect, Giant (GMR) and Tunnel (TMR) Magnetoresistance Sensors may be used. Anisotropic magnetoresistance (AMR) sensors could be incorporated but have been shown to be less sensitive. EMAT is also used with the meanders on the circuit board. By knowing the position of the sensor, using GPS or a higher accuracy locating system defects in the rail can be flagged for repair.

In one aspect of the disclosure, a probe for a rail inspection system includes a moving carrier having a direction of motion. The probe includes a magnetic circuit having a first leg comprising a first end and a second end, a second leg spaced-apart from the first leg, the second leg comprising a first end and a second end, and a yoke magnetically coupling the second end of the first leg and the second end of the second leg. The magnetic circuit generates a magnetic field aligned with the direction of motion, and at a center point between the first leg and the second leg no motion-induced current is present under defect free conditions of the rail. A circuit board extends between the first leg and the second leg. A plurality of magnetic sensors is disposed proximate the center point.

In another aspect of the disclosure, an inspection system for a rail includes an electromagnetic acoustic transducer system generating a first output signal, a magnetic flux leakage system generating a second output signal, and a motion-induced eddy current system generating a third output signal. A position system generates a position signal. A controller is coupled to the electromagnetic acoustic system, a magnetic flux leakage system and the motion-induced eddy current system. The controller determines a defect in the rail based on at least one of the first output, the second output and the third output signal and a location of the defect based on the position.

In yet another aspect of the disclosure, a method of inspecting a rail includes generating a magnetic field in the rail from a magnetic circuit so that the magnetic field is aligned with a direction of motion along the rail, generating first signals from magnetic sensors positioned between legs of the magnetic circuit, directing laser beams to the rail, generating transmitting coil signals from a first meander disposed at a first leg of the magnetic circuit, generating receiving coil signals from a second meander and determining a defect in the rail based on the first signals and the receiving coil signals.

The proposed MIEC method represents a significant advancement in rail safety technology. It offers a more effective solution for detecting Rolling Contact Fatigue (RCF) defects under high-speed conditions, potentially reducing railway accidents and associated economic losses.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1A is a schematic of a probe or sensor used for testing a rail together with a laser system.

FIG. 1B is a side view of the sensor of FIG. 1A.

FIG. 1C is a longitudinal side view of the sensor of FIG. 1A within a carrier.

FIG. 1D is a block diagrammatic view of the sensor electronics.

FIG. 1E is a detailed diagrammatic view of the controller of FIG. 1D.

FIG. 2A is a top diagrammatic view of the sensor.

FIG. 2B is a side and bottom perspective view of the sensor.

FIG. 2C is a top view of the circuit board which may be divided into three circuit boards.

FIG. 3A is a B-scan showing defect locations.

FIG. 3B is a plot of magnetic flux leakage versus position for FIG. 3A.

FIG. 4A is Rayleigh wave dispersion finite element model.

FIG. 4B is a plot of wave velocity versus phase 1 thickness for various thicknesses used for FIG. 4A.

FIG. 5A is a finite element model for Rayleigh wave interaction with vertical cracks.

FIG. 5B is a transmission coefficient versus crack length normalized to wavelength for FIG. 5A.

FIG. 6A is a finite element model showing Rayleigh wave interaction with oblique cracks.

FIG. 6B shows two different geometries for cracks.

FIG. 6C is a transmission coefficient versus crack angle for one millimeter depth.

FIG. 6D is a transmission coefficient versus crack angle for two millimeter depth.

FIG. 6E is a transmission coefficient versus crack angle for three millimeter depth.

FIG. 7A is a finite element model for Rayleigh wave interaction with an array of cracks.

FIG. 7B is a transmission coefficient plot versus the number of cracks.

FIG. 8A is a finite element model showing Rayleigh interaction with branched cracks.

FIG. 8B is a first geometry of a branched crack.

FIG. 8C is an example of a second geometry for a branch crack.

FIG. 8D is a transmission coefficient versus branch length for showing branch angle defects at various angles.

FIG. 9 is a schematic of MIEC system with an electromagnet.

FIG. 10A shows the sensor of FIG. 9 for a track of MIEC for the rail at a 3.125 mph speed.

FIG. 10B shows the sensor of FIG. 9 for a track of MIEC for the rail at a 12.5 mph speed.

FIG. 10C shows the sensor of FIG. 9 for a track of MIEC for the rail at a 62.5 mph speed.

FIG. 11 is a plot of the vertical component of MIEC signals due to a flaw at different speeds.

FIG. 12 is one example of a laser system according to the present disclosure.

FIG. 13 is a schematic of another optical system according to the present disclosure.

FIG. 14A is a diagrammatic view for testing different numbers of lasers relative to a wedge probe and receiver.

FIG. 14B is a voltage versus time plot for one source using FIG. 14A.

FIG. 14C is voltage versus time plot for six sources used in FIG. 14A.

FIG. 15 provides a plurality of plots for spectral magnitude versus frequency in megahertz for one, two, three, four, five and six laser sources.

FIG. 16 illustrates voltage versus time and spectral magnitude versus time for received waves with no grating.

FIG. 17A is a pitch plot for 2.65 mm.

FIG. 17B shows a pitch of 2.65 mm using a line length of 3 mms for the lasers.

FIG. 17C is a plot of laser line lengths of 5 mm using a pitch of 2.65 mm.

FIG. 18 is a perspective view of an ultrasonic transducer relative to laser beams on a rail sample.

FIG. 19 provides an amplitude versus time plot and magnitude versus frequency plot for one point source or six point laser sources.

FIG. 20 shows another example of temporal and spectral energy between one line source and six line laser sources with a 2.65 mm pitch.

FIG. 21 is a plot of magnitude versus frequency for six line sources versus six point sources.

FIG. 22 illustrates a comparison between laser power at 90, 100 and 110 amps for 5 mm line sources.

Corresponding reference numerals indicate corresponding parts throughout the several views of the drawings.

### DETAILED DESCRIPTION

Example embodiments will now be described more fully with reference to the accompanying drawings.

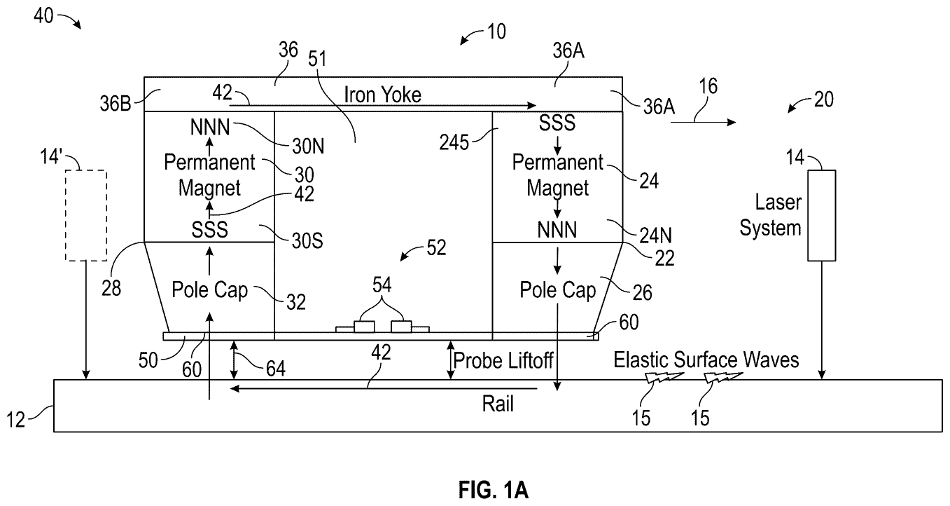

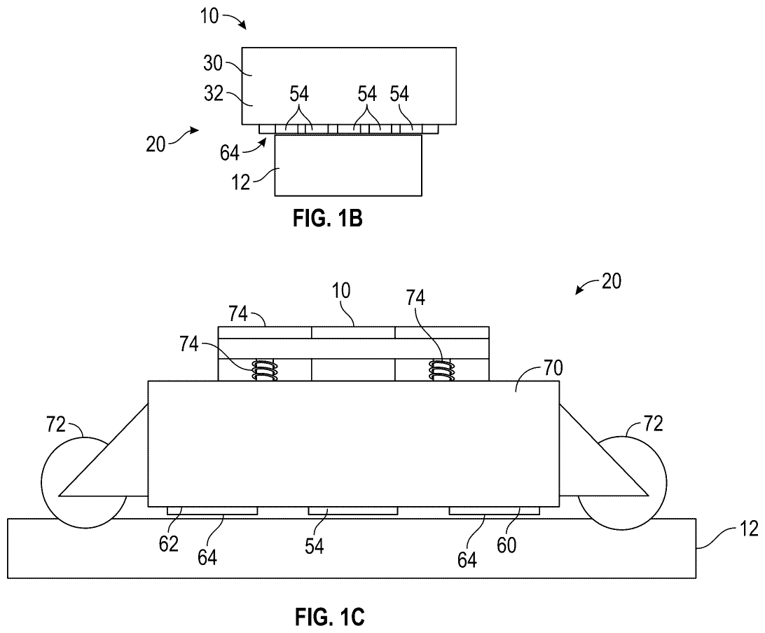

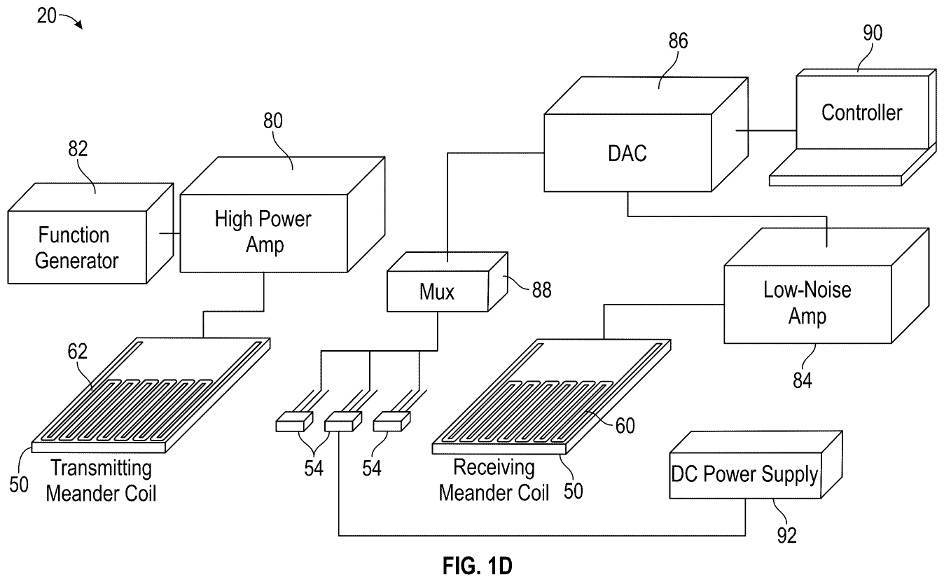

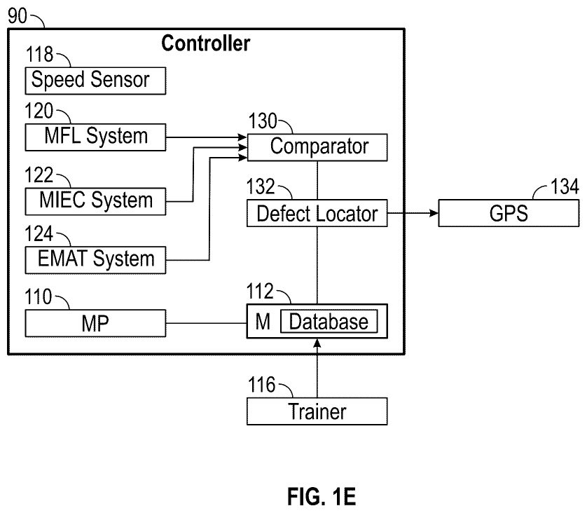

Referring now to FIGS. 1A, 1B and 1C, an electromagnetic sensor or probe 10 is disposed relative to a train rail or rail 12. The rail 12 is formed of steel which has magnetic characteristics. The electromagnetic probe 10 forms the basis of an acoustic transducer (EMAT) system, a magnetic flu leakage (MFL) system and motion-induced eddy current (MIEC) transducer system. The probe 10 is coupled with laser system 14 that is positioned forward or rearward (as illustrated at 14′) of the probe 10 relative to a direction of travel 16. The system 20 uses an ultrasonic approach that provides a fully non-contact and nondestructive evaluation tool that will be very useful for rail inspection at full speed.

FIGS. 1A-1C show the schematic of the hybrid probe 10 that has a unified magnetic path for biasing both EMAT meander coils and the MFL and MIEC Hall effect sensors. The probe 10 includes a first leg 22 that has a permanent magnet 24 with a north pole 24N and a south pole 24S. The permanent magnet 24 may have a pole cap 26 that is disposed adjacent to the north pole 24S of the permanent magnet 24. The permanent magnet 24 and the pole cap 26 form the first leg 22. A second leg 28 includes a permanent magnet 30 having a north pole 30N and a south pole 30S. A pole cap 32 is disposed adjacent to the south pole 30S. The pole cap 26 is also adjacent to the south pole 24S of the first leg 22.

A yoke 36 is elongated and has a first end 36A disposed adjacent to the south pole 24S of the permanent magnet 24. A second end 36B of the yoke 36 is disposed adjacent to the north pole 30N of the permanent magnet 30. The yoke 36 may be formed of magnetic material such as iron. A magnetic circuit 40 is formed as indicated by the arrows 42. The magnetic flux travels in the direction as indicated by the arrows 42 from the permanent magnet 24 through the pole cap 26, through the rail head or rail 12, through the pole cap 32 through the permanent magnet 30 and through the yoke 36 back toward the permanent magnet 24.

The laser system 14 will be greater detail below. However, the laser system 14 generates a plurality of laser beams that are directed onto the surface of the rail 12 and generate elastic surface waves 15 which travel the probe 10 and are used by the EMAT system as described below.

A circuit board 50 is coupled to the pole caps 26 and 32. The circuit board 50 is disposed across the space 51 between the legs 22, 28 and adjacent to a center position 52 between the first leg 22 and the second leg 28. A plurality of magnetic sensors 54 are disposed proximate the center position 52 of the probe 10. The sensors 54 are disposed in an array. The magnetic sensors 54 may include but may not be limited to a Hall effect sensor, a giant magnetoresistance sensor (GMR), a tunnel magnetoresistance sensor and an anisotropic magnetoresistance (AMR) sensors. The circuit board 50 as will be described in greater detail below has a receiving meander coil 60 and a transmitting meander coil 62.

As is best illustrated in FIG. 1B, the sensors 54 may be disposed across the width of the rail 12.

The circuit board 50 and the coils 60, 62 may be spaced apart from the rail by a distance referred to as a probe liftoff 64. The probe liftoff 64 is maintained during testing to allow the non-destructive procedure. Although the circuit board 50 is shown as one continuous circuit board, independent circuit boards for the meander coils 60, 62 and Hall sensors (magnetic sensors 54) may be used. This would allow the probe liftoffs for each meander coil 60, 62 and the Hall sensors to be adjusted independently.

Referring now specifically to FIG. 1C, a carrier 70 may be used to support the probe 10 relative the rail 12. Rollers 72 coupled to the carrier may have the probe 10 with spring loaded mounts 74 used to position the probe 10 so that the probe liftoff 64 is formed and maintained between the coils 60 and the rail 12. It should be noted that the gap or center position 52 between the legs 22 and 28 allow no motion-induced current to be present under defect free conditions of the rail. Conversely, when a defect in the rail is present, some motion-induced current may be present at the center point between the two legs 22, 28 and therefore the sensors 54 can detect the change in the magnetic field. This will be described in greater detail below.

FIG. 1D shows a schematic of the electronics of the system 20. The pole caps 26, 32 allow amplification of the magnetic field on the meander coils 60, 62 and close the loop on the magnetic sensors 54.

The transmitting meander coil 62 is formed as meander on the circuit board 50. The receiving meander coil 60 is formed as a receiving meander coil on the circuit board 50. The meander coils 60, 62 may be directly adjacent to the end of the pole caps 26, 32.

The transmitting meander coil 62 may be in communication with a high power amplifier 80 which, in turn, is electrically coupled to a function generator 82 that is used to generate various function signals appropriate for testing the rails. Details of this will be provided below. The receiving meander coils 60 are in communication with a low noise amplifier 84 and a digital-to-analog converter 86. The digital-to-analog converter 86 converts the digital signals from the low noise amplifier to an analog signal.

A multiplexer 88 is coupled to the magnetic sensor 54. The multiplexer 88 groups the electrical signals from the magnetic sensors and multiplexes the electrical signals which are communicated from the multiplexer 88 to the digital-to-analog converter 86. The signals from the digital-to-analog converter 86 are communicated to a controller 90. The controller 90 is ultimately used to identify defects by comparing the signals to known characteristics of different types of defects.

The system 20 may also include a DC power supply 92 that is coupled to various components including the magnetic sensor 54.

Referring now also to FIG. 1E, details of the controller 90 are illustrated. The controller 90 may include a microprocessor or processor 110. The processor 110 is used to execute various commands and perform the detection of defects in the rail 12 illustrated above. The processor 110 is in communication with a memory 112. The memory 112 may be a non-transitory computer-readable medium including machine-readable instructions that are executable by the processor 110. The machine readable instructions include methods for operating the system. A database 114 may also be included within the memory 112. The database 114 may provide a plurality of characteristics for different types of defects as will be described in greater detail below. Ultimately, a trainer 116 may be used to train the database 114 with various defects for the different types of detection system as described below.

The controller 90 may also include a speed sensor 118. The speed sensor 118 may be incorporated into the system 20 or may be a separate system or part of the train or carrier 70. The speed sensor 118 may generate speed signals corresponding to the speed of the carrier 70 relative to the rail 12.

The controller 90 may include a magnetic flux leakage (MFL) system 120, a motion-induced eddy current (MIEC) system 122 and an electromagnetic acoustic transducer (EMAT) system 124. As will be described in greater detail below, the MFL system 120, the MIEC system 122 and the EMAT system 124 each generate output signals from the meander coil 60 or the magnetic sensor 54 that are communicated to a comparator 130. The comparator 130 compares the signals to the database 114 to classify defects in the rail. The specific type of defect or merely the presence of defect may be determined. A defect locator 132 uses a position system such as a GPS system 134 or another type of location system such as LORAN so that the exact position of the defect in the rail may be saved within the memory 112 and the rail may ultimately be replaced.

The MFL system 120 may be used at no speed or low speed as detected by the speed sensor 118. That is, below a predetermined speed threshold such as 3.5 or 5 miles per hour, the MFL system may not operate.

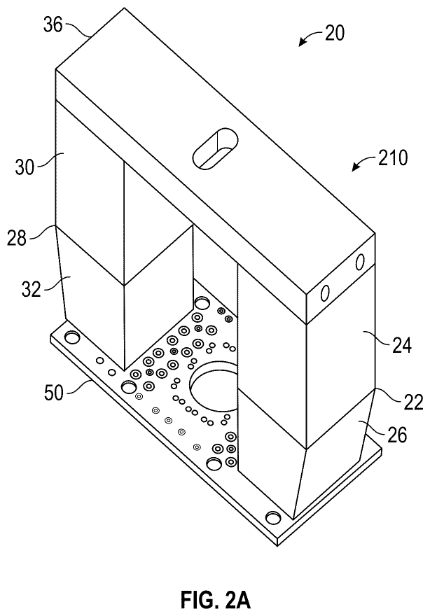

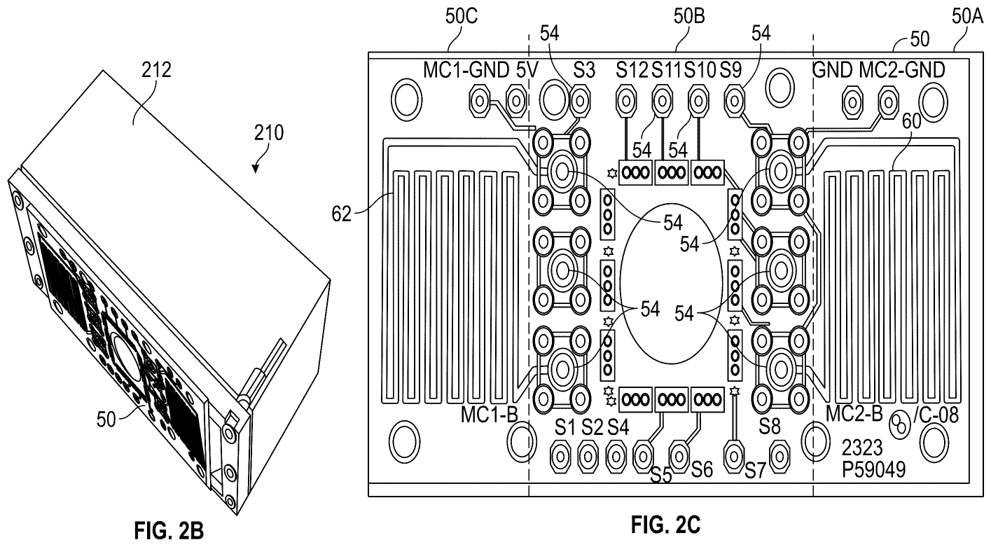

Referring now to FIGS. 2A-2C, the integrated circuit board 50 and yoke 36 may assembled using a 3D printed box 210 as shown. The box 210 allows independent change the EM and EMAT liftoffs which is valuable for rail inspection. The box 210 may include a sidewall 212 that extends between the first leg 22 and the second leg 28. This is best illustrated in FIG. 2B.

Referring now specifically to FIG. 2C, the meander coils 60, 62 are illustrated along with relative locations of the sensors 54. The separate circuit boards 50A, 50B and 50c may be used as mentioned above to three different liftoffs are possible. A support structure and electrical connectors (not shown) may couple the individual circuit boards 50A-50C together.

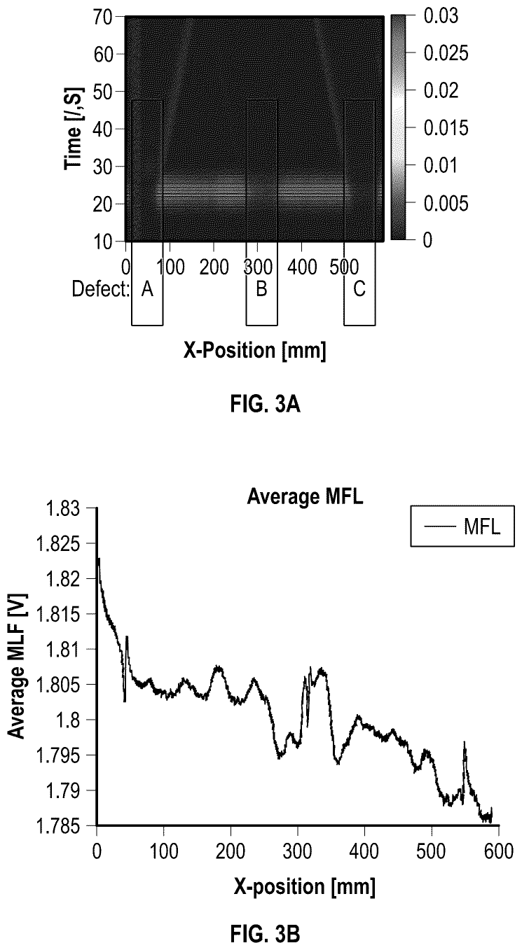

Referring now also to FIGS. 3A and 3B, the use of the probe 10 to detect three different defects A, B, C is set forth by way of example. The probe 10 can detect all three defects, but localization of the defects is difficult and challenging. However, the MFL system 120 can detect all defects and localize them, but characterization remains to be done. The characterization of the defect using the EMAT 124 is possible. In FIG. 3A, an EMAT B-Scan showing the defect locations, and in FIG. 3B, the MFL results showing the various defects. The data was collected using acoustic wave inspection using EMAT.

The database 114 with results for different types of cracks and crack geometries was experimentally determined. The curves in this database may be normalized to the Rayleigh wavelength, which allows development of calibration curves for direct inversion/characterization of defects from experimental data. This also demonstrates that the system 20 is sensitive to RCF type of defects using surface acoustics waves that maybe generated using the EMAT system.

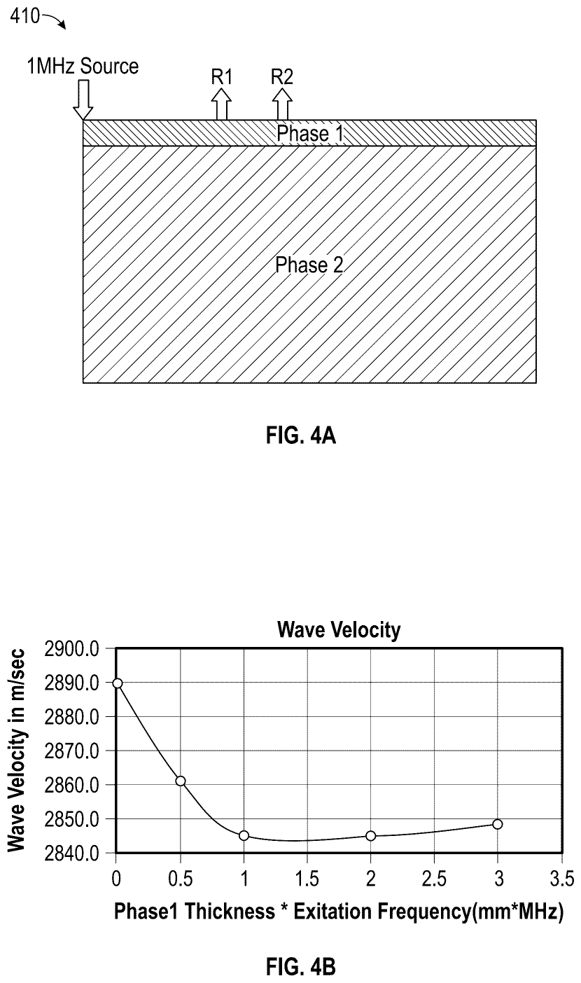

Referring now to FIGS. 4A and 4B, the formation of defects in rails happens in various stages. In the first stage of defect formation, a phase transformation from pearlitic steel to martensitic or mixed phase takes place. This typically forms a thin layer on the top surface due to deformations from rail wheel braking. To characterize this difference in phase, the concept of Rayleigh wave dispersion in multilayered media may be used. A finite element model 410 was constructed. Phase 1 and phase 2 were given different properties based on their composition. For example, phase 1 was given martensite and phase 2 was attributed with pearlite. The Rayleigh wave excitation frequency was fixed at 1 MHz, but the thickness of the phase 1 material was varied. As shown in FIG. 4B, at smaller thickness of phase 1, the velocity correlates well with phase 2 material, and at larger thickness values of phase 1 material, the velocity approaches the phase 1 layer. This asymptotic dispersion effect is expected and has been reported. This shows that the variation of the thickness of the surface layer can be accounted for in the characterization process.

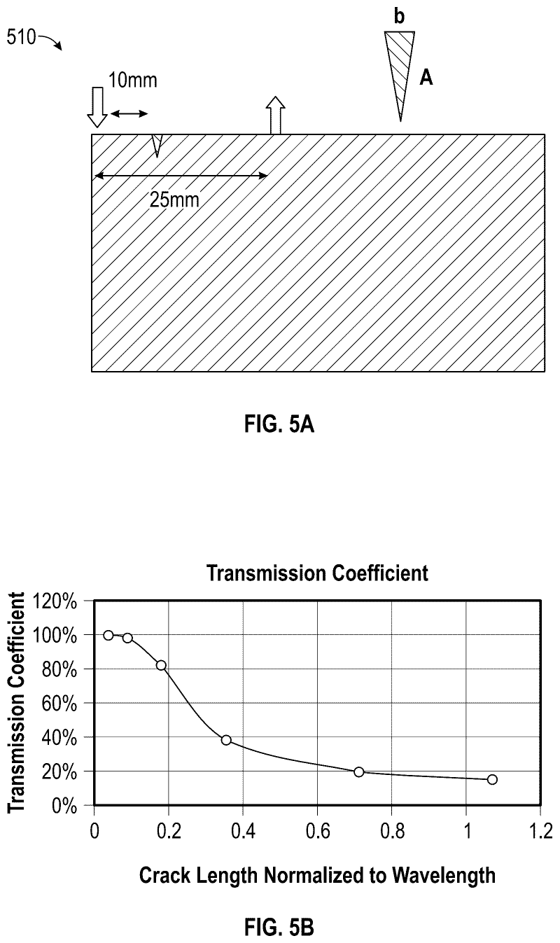

Referring now to FIGS. 5A and 5B, vertical and normal cracks may form in the rail 12. As the microstructure defects evolve, cracks result, which can be normal or oblique to the surface. This combination typically forms the stage II cracks. For any vertical crack, a finite element model 510 is shown in FIG. 5A. The crack was positioned 10 mm from the excitation, and the transmitted wave was received at 25 mm from the source. To get the transmission coefficient, the received waveform for the cases with and without crack was divided; (Tc=Ac/Ai), where Ai is the case without any cracks. This gives us the transmitted Rayleigh energy as a function of crack length as shown in FIG. 5B. The exponential relationship is consistent with previously reported results for vertical cracks.

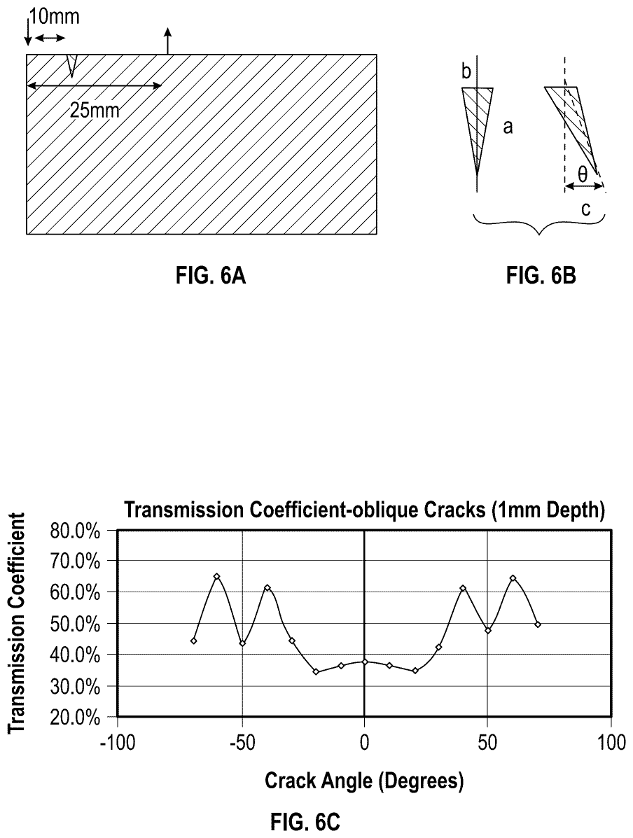

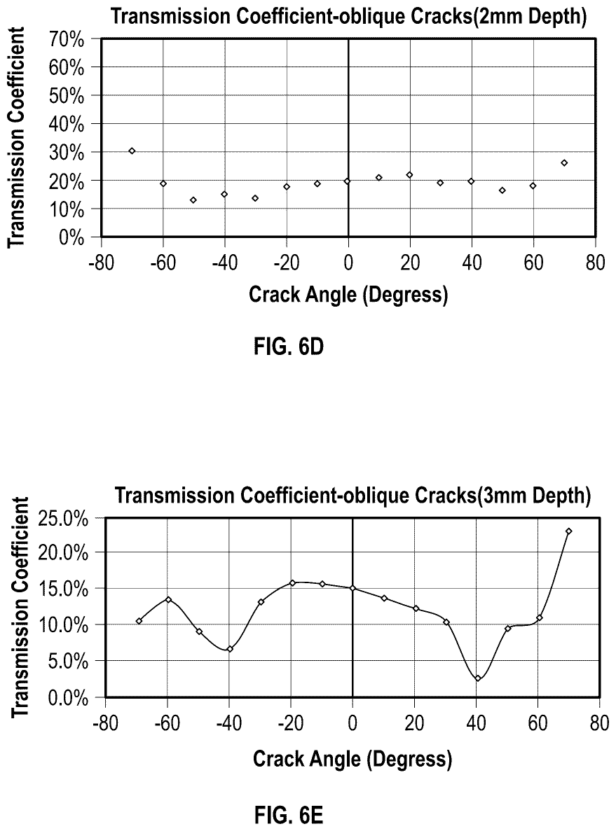

Referring now to FIGS. 6A-6E, to study the effect of the crack orientation on Rayleigh wave propagation, crack geometry was modified to introduce the orientation angle (theta). However, this also introduces two variables: the transmission coefficient becomes a function of orientation angle, and the crack length; Tc(q, L). This was explored by fixing L, and changing the angle Theta as shown in FIGS. 6B-E. The transmission coefficient for different values of crack angle; (−70 to +70 degrees) with respect to the normal as shown in FIGS. 6C-6E. This was repeated for L ranging from 1 mm to 3 mm. at 3 mm, the crack length matches the Rayleigh wavelength, therefore transmission will be minimum as shown in FIGS. 6C-6E. The results show that at smaller crack lengths, the response is symmetric, but at higher crack length, an asymmetry can be observed between the positive and negative angles.

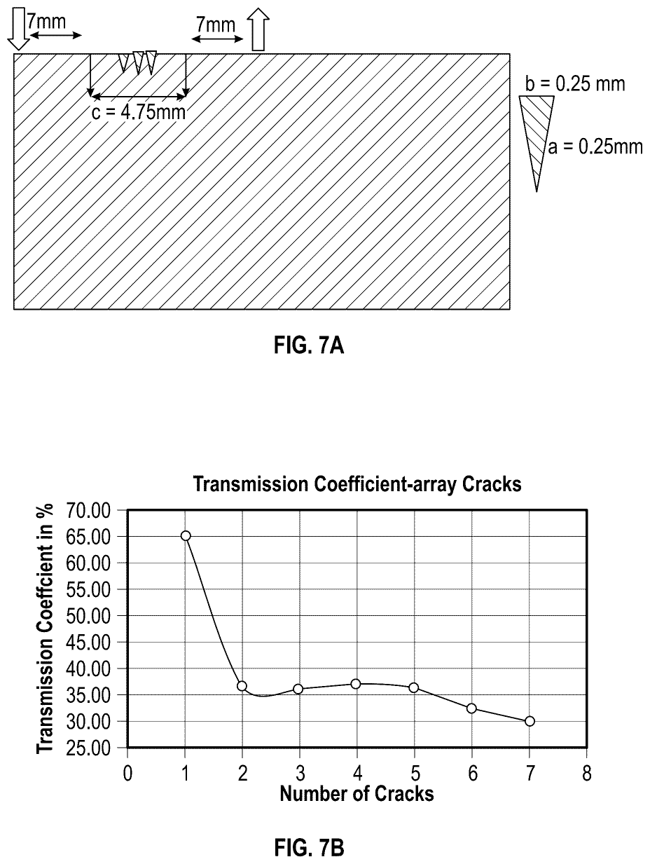

Referring now to FIGS. 7A and 7B, as the cracks progress in stage II, shear lag effects can result in array crack formation. These are multiple cracks of similar or different lengths, which are all surface breaking in nature. They form an array of cracks which can further coalesce to form larger cracks or connect between them to form other types of defects. To study the effect of array crack on Rayleigh wave propagation, a model using a series of cracks separated by constant distance was developed. The crack lengths were similar at 0.5 mm. The number of cracks was changed as shown in FIG. 7A. As the number of cracks increases, it was noticed that transmission coefficient decreases as shown in FIG. 7B. However, interestingly, the biggest change is observed when the number of cracks increases from 1 to 2.

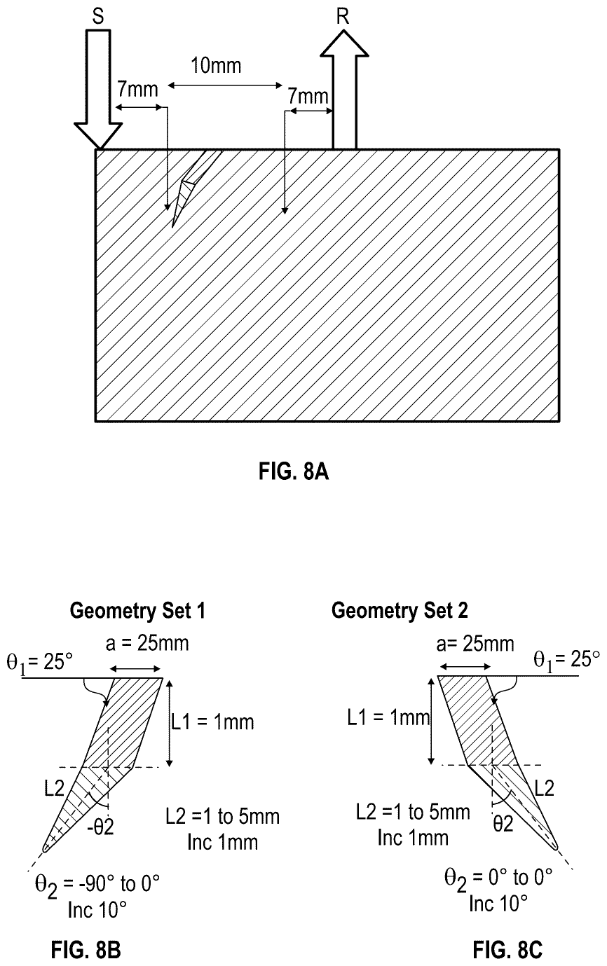

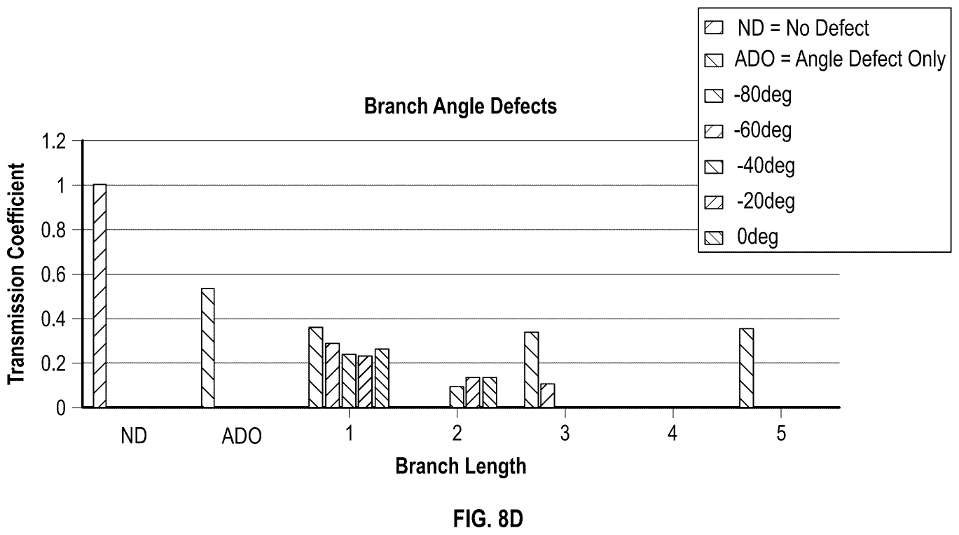

Referring now to FIGS. 8A-8D as the defect evolution continues into Stage Ill branch cracks begin to form. This can be visualized as a two-pivot line segments as shown in FIGS. 8B and 8C. The first line segment has an orientation and length, followed by a 2nd line segment with a different angle and line length. These two segmented cracks are referred to as branched crack in this report. The challenge with detecting these that there are several different combinations; four parameters (L1, L2, q1, q2). Where L1 is the length of the line segment connecting to the surface, L2 is the branch length, q1 is the first angle, and q2 is the 2nd angle. However, to limit this number of cases, L1=1 mm and q1=250 and q2, L2 re changed. The Rayleigh wave transmission coefficient for different combinations of these parameters is shown in FIG. 8D.

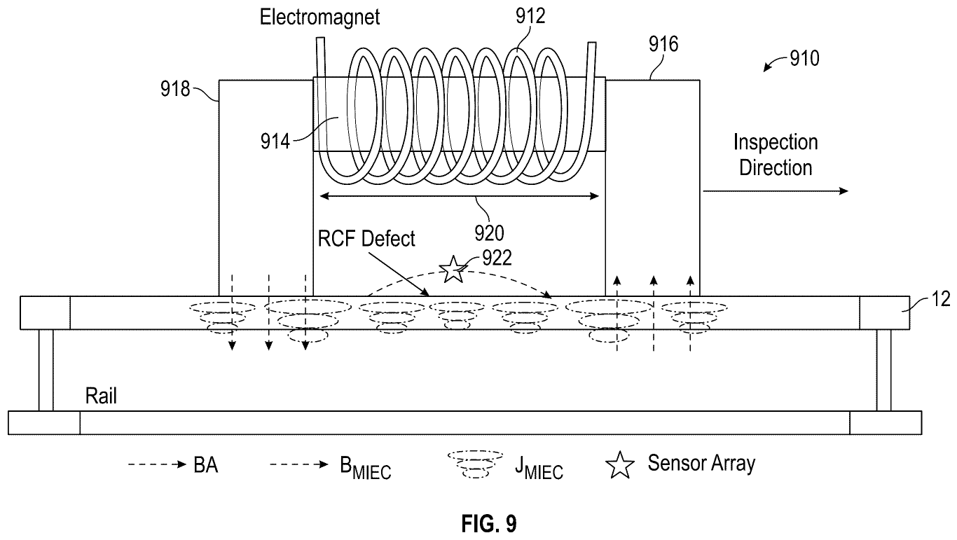

Referring now to FIG. 9, the present system introduces an innovative Motion-Induced Eddy Current (MIEC) technique designed for high-speed, high-accuracy rail inspections. The method stands out for its exceptional Signal-to-Noise Ratio (SNR), heightened sensitivity, and capability to identify defects at velocities reaching 60 mph. The MIEC system harnesses the dynamic interaction between an electromagnet and the rail track. This interaction is pivotal in generating motion-induced eddy currents within the track, conforming to Maxwell's equations.

A distinctive feature of this method, setting it apart from previous velocity-induced eddy current techniques, is the alignment of the magnetic field. In the present MIEC method, the magnetic field is oriented parallel to the direction of relative motion. This unique orientation is an improved aspect of the improved effectiveness. A simplified probe 910 is illustrated. However, the probe 910 may be formed in a similar manner to that illustrated in FIG. 1A. In this example, an electromagnet 912 is formed around a yoke 914 that extends between the legs 916 and 918. A distance 920 separates the insides of the legs 916 and 918. However, permanent magnets, such as those illustrated in FIG. 1A, may be used.

In the present MIEC technique, strategic placement of the magnet's poles at legs 916 and 918 plays a role. When these poles in the legs 916, 918 are set at a sufficient distance 920 apart, the magnetic field generated at the midpoint 922 between the poles aligns longitudinally with the rail 12, mirroring the train's direction of movement. This alignment results in a zero motion-induced current at the center 922, in accordance with Maxwell's Laws. Positioning a magnetic sensor at this midpoint to measure the vertical component of the magnetic field would typically yield a null signal, signifying the absence of defects under low-speed conditions.

However, the presence of rail inhomogeneities, such as Rolling Contact Fatigue (RCF), alters this scenario. An RCF defect disrupts the longitudinal orientation of the magnetic field at the center 922. Consequently, the cross product of the relative velocity (V) and magnetic flux density (B) deviates from zero, generating a detectable signal. This feature categorizes the new probe as self-nulling, as it naturally produces a zero signal in flaw-free scenarios under low-speed conditions, thus streamlining analysis and reducing bias in signal processing.

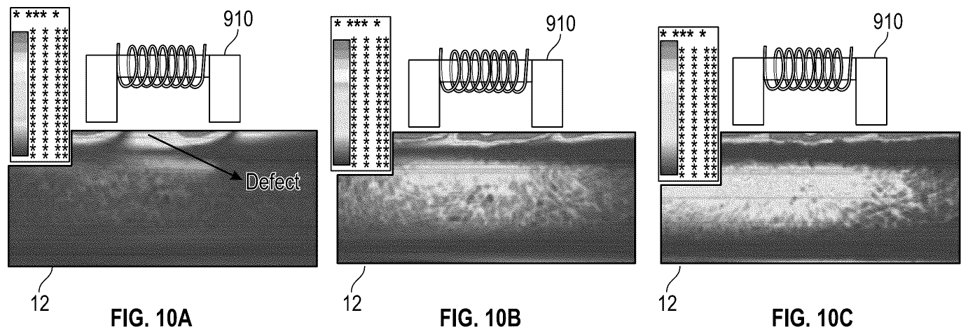

Referring now also to FIGS. 10A-10C, under higher velocity conditions, the dynamics change significantly. Velocity-induced currents, especially near the poles, lead to wake effects comprising a trail of motion-induced current in the rail as the magnet advances. This effect is illustrated in FIGS. 10A-10C. The magnetic sensors, stationed to capture the vertical component of the field at the midpoint, register a shift in the signal. Even in the absence of rail defects, the signal at the center will deviate from zero due to these wake effects, providing crucial information about the rail's condition at higher speeds. Speeds vary from 3.125 mph in FIG. 10A to 12.5 mph in FIG. 10B to 62.5 mph inn FIG. 10C.

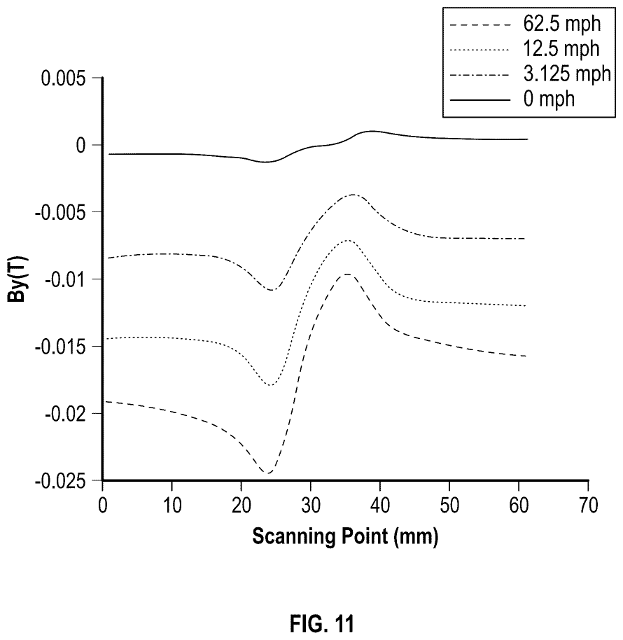

Referring now also to FIG. 11, in this innovative MIEC method, the central magnetic sensor, designed to measure the vertical component, detects a shift in the signal under certain conditions. Notably, even in a homogeneous, defect-free rail environment, this central signal will not remain at zero. This phenomenon is graphically depicted in FIG. 11, illustrating how the signal's vertical component changes in response to a flaw, especially as velocity increases from 0 mph to 3.125 mph, to 12.5 mph to 62.5 mph.

An innovation of this approach is the employment of a sensor array rather than relying on a single sensor. This configuration enables the selection of a specific sensor from the array, based on the current velocity, to ensure a null signal is obtained under quiescent or defect-free conditions. This strategic use of multiple sensors enhances the method's adaptability and accuracy.

Extensive simulation studies have been conducted to assess the feasibility and performance of the MIEC method. These studies have validated the approach, revealing a clear relationship between velocity and the efficacy of the MIEC technique. The results indicate that higher speeds lead to increased MIEC density and greater amplitude of MIEC defect signals. This correlation suggests a significant improvement in inspection capabilities compared to existing methods.

Consequently, the MIEC method demonstrates exceptional potential for the high-speed detection of Rolling Contact Fatigue (RCF) defects in rail tracks, marking a substantial advancement in rail safety technology.

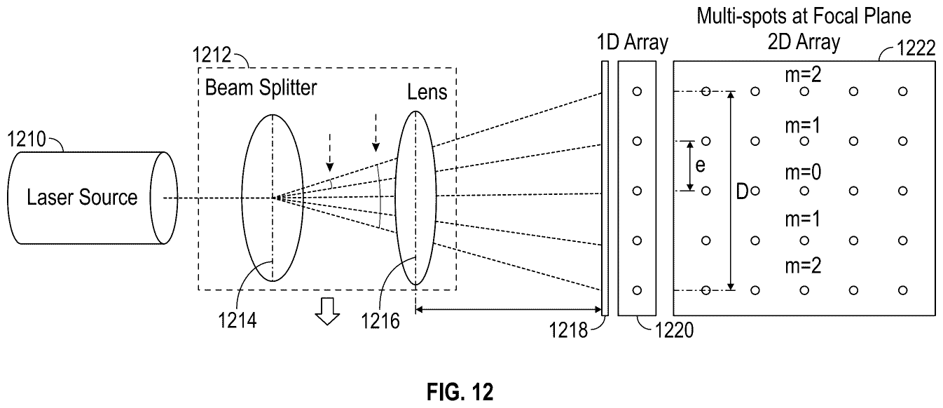

Referring now to FIG. 12, the laser system 14 of FIG. 1 is described in greater detail. In one example, an array of mirrors was proposed to be placed in an arc to excite multi-sources and act like a comb transducer. The laser system 14 is illustrated in greater detail. The laser system 14, in this first example, includes a laser source 1210, an optical system 1212 that includes a beam splitter 1214 and a lens 1216. The beam splitter may split the beam into a number of beams, such as five beams in this example. A one dimensional array 1220 may be formed by the optical system 1212. However, a grating 1218 may be used to form a two-dimensional array 1222, in this example, the five laser beams are each split from the one dimensional array 1220 into five other beams to form a two dimensional array, five beams by five beams. Of course, various numbers of beams may be generated.

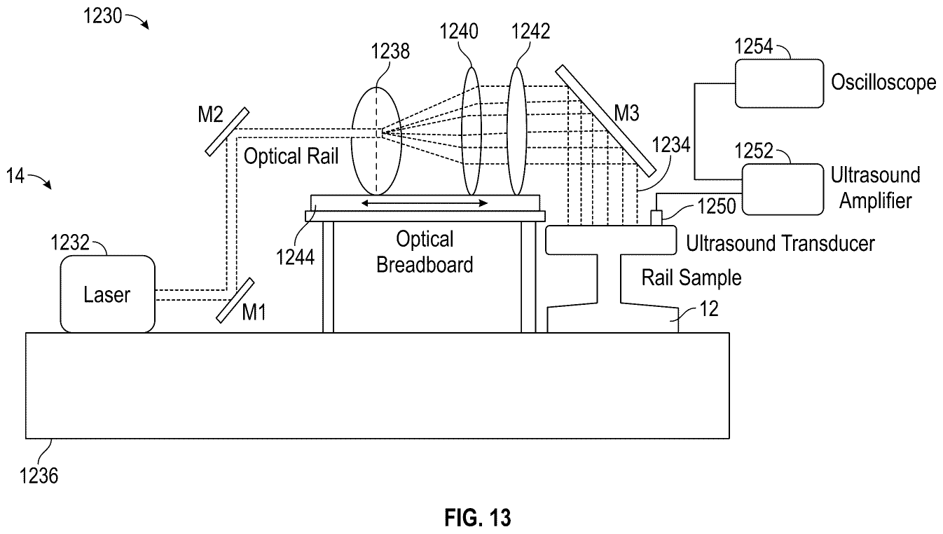

Referring now to FIG. 13, a more detailed diagram of the laser system 14 is set forth. A line source generator 1230 was designed for generating a line source from a laser source 1232. In this example, the laser source 1232 generates a single laser beam that is split ultimately into six laser beams 1234 in a line. In the lab, a 4 mm pitch and 2.65 mm pitch of laser beams were generated. The line source generator 1230 acts like a true comb transducer for SAW wave generator. Ultimately, the laser source is redirected by a first mirror M1 and a second mirror M2. In the lab, an optical table 1236 was used. However, in the field, the carrier or train car may carry the laser system 14. The second mirror M2 reflects the laser beam toward a beam splitter 1248 that, in this example, generates six laser beams. The laser beams 1234 are optically communicated to a convex cylindrical lens 1240 and through a concave cylindrical lens 1242. The focal length of the convex cylindrical lens 1240 was 20 cm in this example. The focal length of the concave cylindrical lens 1242 was 40 cm in this example. The beam splitter 1238, the convex cylindrical lens 1240 and the concave cylindrical lens 1242 were mounted to an optical bread board 1244.

Ultimately, the six laser beams were reflected from a third mirror M3 toward a rail 12. The line of laser beams was incident on the rail 12. Ultimately, an ultrasound transducer 1250 is used together with an ultrasound amplifier to generate signals from the rail to detect defects. In this example, an oscilloscope 1254 receives the signals from the ultrasound amplifier to determine the presence of a defect, however, the oscilloscope 1254 may be replaced by the controller 90 illustrated above in which the laser system 14 is part of the EMAT system 124 illustrated in FIG. 1E. Ultimately, the comparator 130 of FIG. 1E may compare the output from the ultrasound amplifier 1252 to signals from the database so that defects can be identified and located.

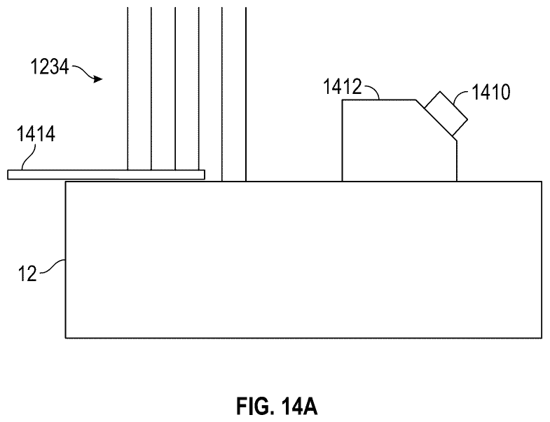

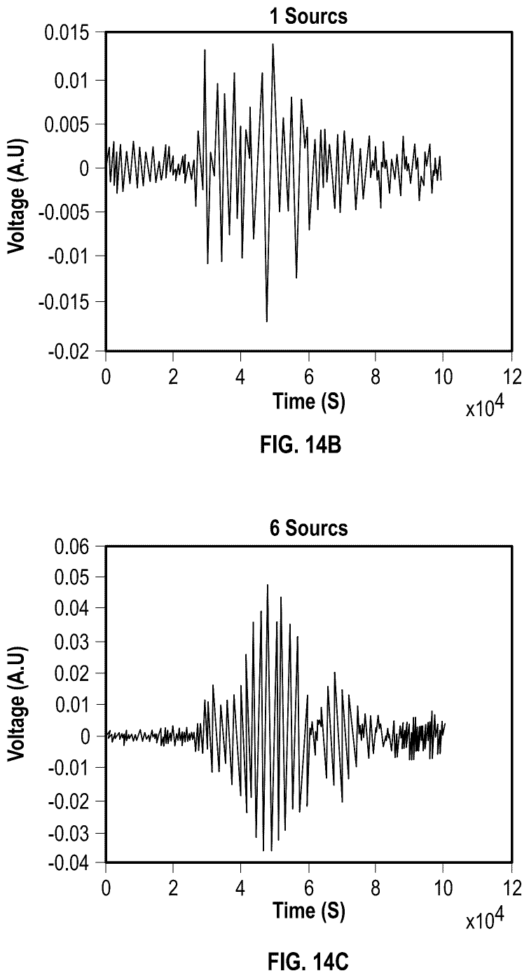

Referring now to FIGS. 14A, a 4 mm pitch grating generate laser waves at the corresponding frequency, i.e. (c=f*lambda), and Lambda=4 mm, c=2850 m/s, therefore, f˜700 KHz. A test setup for the laser beams 1234. The receiver 1410 was a probe mounted on variable angle wedge 1412 that was set to about 60 degree (2nd critical angle for steel). Each beam 1234 was blocked using a blocker 1414 such as a paper card. This allowed a temporary change the number of beams.

In FIGS. 14B and 14C, the voltage versus time for one laser source is illustrated in FIG. 14B while the voltage versus time for six laser sources is illustrated in FIG. 14C.

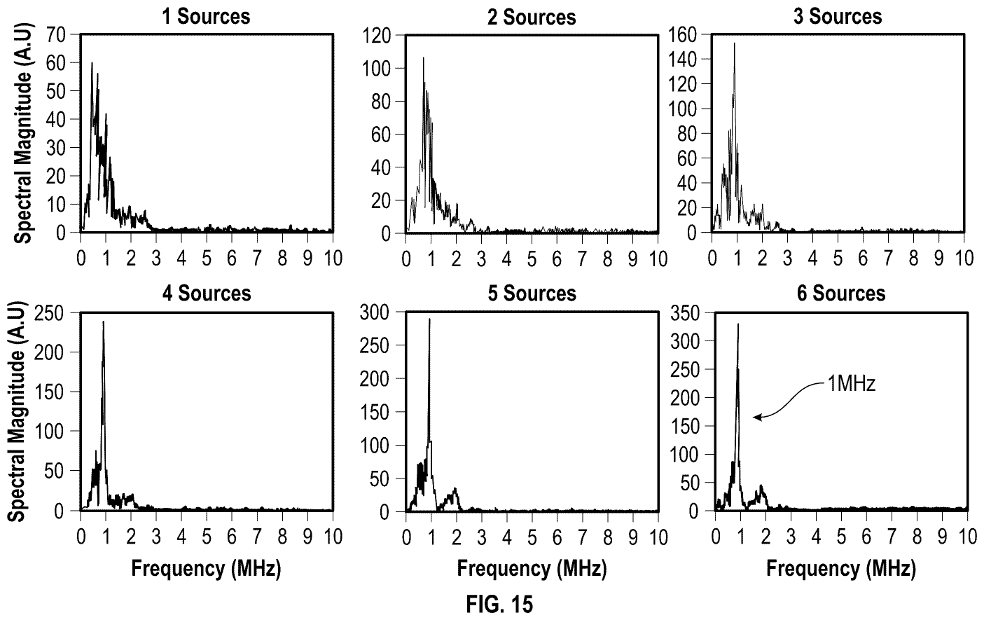

Referring now to FIGS. 15, the advantage of using 6 laser sources vs 1 laser source is more apparent in the A-Scans. However, to analyze the results, it is more important to observe the spectral content as shown in FIG. 15.

FIG. 15 shows that as the number of laser beams or sources is increased, the wavelength matching is more efficient and the source acts more like a comb transducer. This produces a coherent wave with spectral content which is dominant at one frequency. At 6 beams, strong 1 MHz content is achieved.

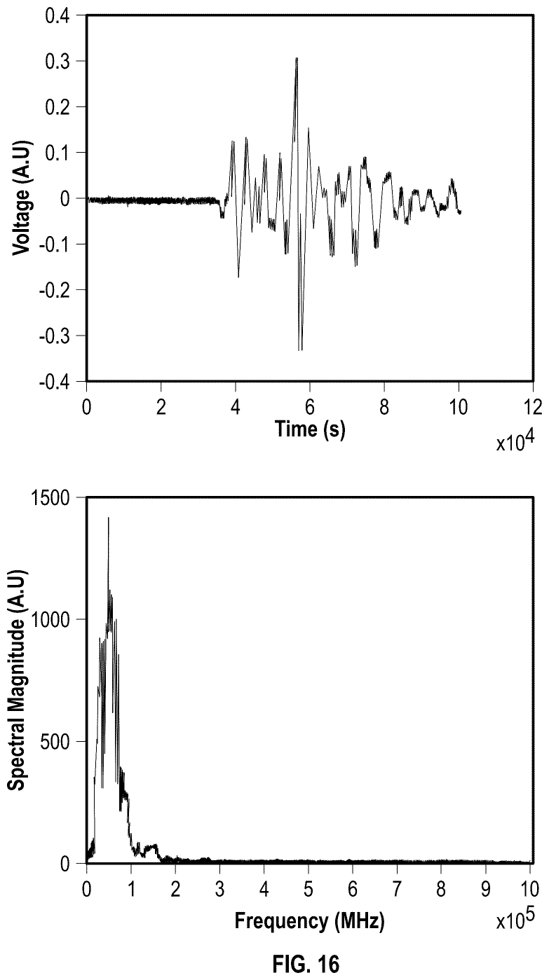

Referring now to FIG. 16, the results were compared to the case with no grating. As shown in FIG. 16, without any grating the incident power is very high, but the spectral distribution is more broadband. A 30-40% loss of energy is obtained when going through the grating. However, producing spectrally coherent waves may be important and therefore a grating may be used.

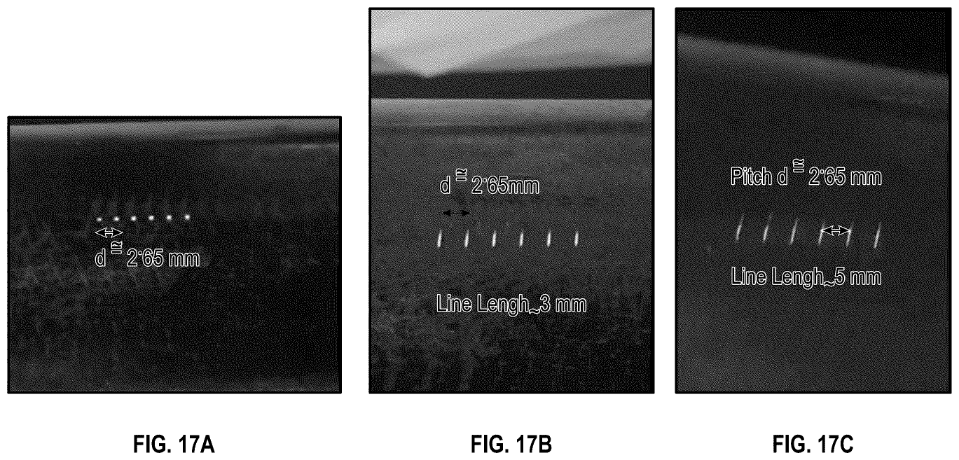

Referring now to FIGS. 17A-17C, the results of 2nd iteration of the design with 2.65 mm pitch is shown. Both line and point sources have the 2.65 mm pitch, but their generation efficiency will be different. FIG. 17A shows point sources. FIG. 17B shows 3 mm line lengths at 2.65 mm pitch. FIG. 17C shows line lengths of 5 mm at 2.65 mm pitch.

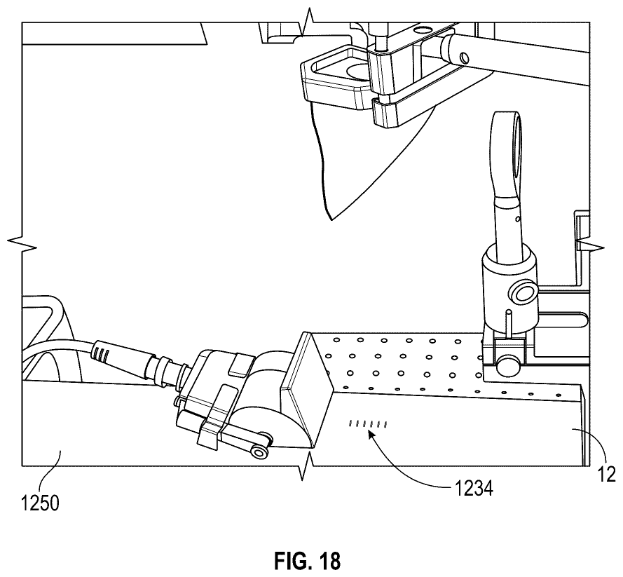

Referring now to FIG. 18, elastic waves were received using contact-based transducer 1250 after the laser beams 1234 hit the rail 12.

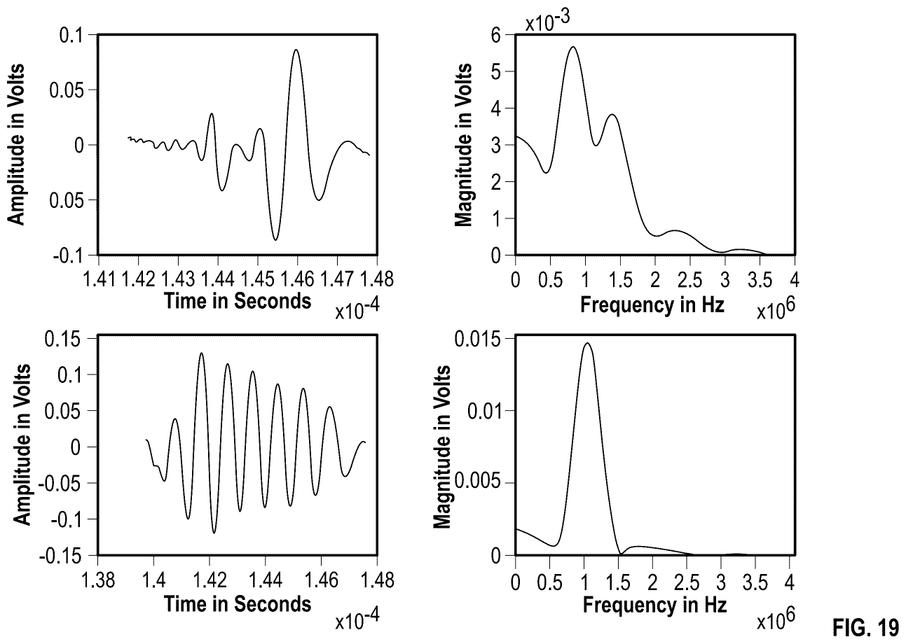

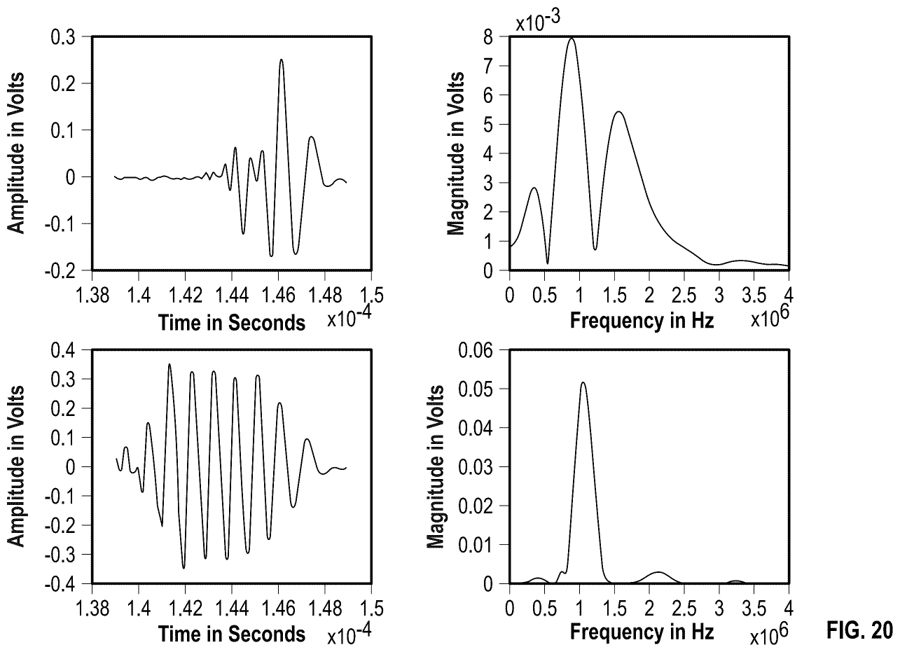

Referring now also to FIG. 19 and FIG. 20, show the spectral and temporal content using one point source and 6 point sources at 2.65 mm pitch.

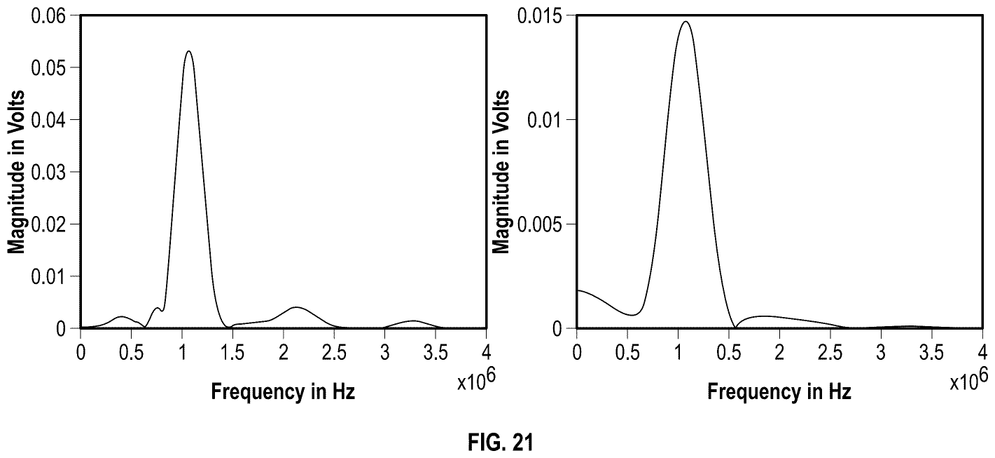

Referring now also to FIG. 21, a spectral energy comparison between point and line sources of 2.65 mm pitch. The comparison between 6-point sources and a single point source clearly shows the advantage of the comb setup. Furthermore, the 6-line sources and single line source of FIG. 21 fortifies these results. From FIG. 20, it can be seen that the line sources have a much higher spectral content compared to the point sources. The proposed configurations seem to be advantageous in increasing the generation efficiency of SAW waves.

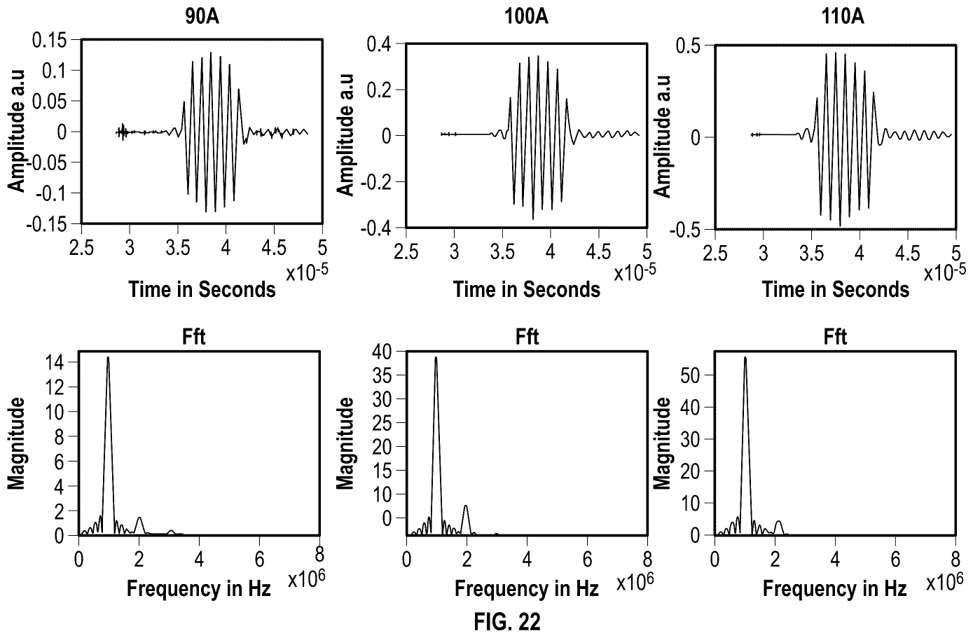

Referring now to FIG. 22. when the 5 mm line width source is used, the wave coherency is much higher than the 3 mm line width case. With increase in laser power, the spectral energy increases, and the waves become more coherent as shown in FIG. 22.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What claimed is:

1. A magnetic probe for measuring defects in a rail, comprising:
a moving carrier comprising a direction of motion;
a magnetic circuit comprising,
a first leg comprising a first end and a second end,
a second leg spaced-apart from the first leg, the second leg comprising a first end and a second end, and
a yoke magnetically coupling the second end of the first leg and the second end of the second leg;
the magnetic circuit generating a magnetic field aligned with the direction of motion, and at a center point between the first leg and the second leg no motion-induced current is present under defect free conditions of the rail; and
one or more circuit boards extending between the first leg and the second leg, and a plurality of magnetic sensors disposed proximate the center point.

2. The magnetic probe of claim 1 wherein the plurality of magnetic sensors comprises at least one of Hall effect sensors, magnetoresistance sensors or anisotropic magnetoresistance sensors.

3. The magnetic probe of claim 1 wherein the first leg is disposed forward relative to the direction of motion.

4. The magnetic probe of claim 1 wherein the second leg is disposed rearward relative to the direction of motion.

5. The magnetic probe of claim 1 wherein the first leg comprises a first permanent magnet comprising a first south pole adjacent to the yoke, and the second leg comprises a second permanent magnet comprising a first north pole adjacent to the yoke.

6. The magnetic probe of claim 5 wherein the one or more circuit boards comprising a receiving coil disposed adjacent to the first end of the first leg, a transmitting coil disposed adjacent to the first end of the second leg.

7. The magnetic probe of claim 6 wherein the transmitting coil is coupled to a high-power amplifier and a function generator.

8. The magnetic probe of claim 6 wherein the first leg comprises a first pole cap disposed between the receiving coil and a first north pole of the first permanent magnet and wherein the second leg comprises a second pole cap disposed between the transmitting coil and a second south pole of the second permanent magnet.

9. The magnetic probe of claim 8 wherein the receiving coil is formed by a first meander on the one or more circuit boards and the transmitting coil is formed by a second meander on the circuit board.

10. The magnetic probe of claim 6 wherein the receiving coil is coupled to low noise amplifier and a digital-to-analog converter.

11. The magnetic probe of claim 10 wherein the plurality of magnetic sensors is coupled to a multiplexer and the digital-to-analog converter.

12. The magnetic probe of claim 11 wherein the digital-to-analog converter is coupled to a controller for classifying defects in the rail based on signals from the multiplexer and the digital-to analog converter.

13. The magnetic probe of claim 1 further comprising a laser source generating a laser beam directed to the rail.

14. The magnetic probe of claim 13 wherein the laser source is optically coupled to a beam splitter generating a plurality of beams, said plurality of beams directed to the rail.

15. The magnetic probe of claim 14 further comprising a concave lens, convex lens and a mirror redirecting the laser beam to the rail.

16. An inspection system for a rail comprising:
an electromagnetic acoustic transducer system generating a first output signal;
a magnetic flux leakage system generating a second output signal;
a motion-induced eddy current system generating a third output signal;
a position system generating a position signal; and
a controller coupled to the electromagnetic acoustic system, a magnetic flux leakage system and the motion-induced eddy current system, said controller determining a defect in the rail based on at least one of the first output, the second output and the third output signal and a location of the defect based on the position.

17. The inspection system of claim 16 further comprising a magnetic circuit having a first leg, second leg and a circuit board comprising magnetic sensors positioned between the first leg and the second leg.

18. The inspection system of claim 17 wherein the electromagnetic acoustic system generating laser beams directed at the rail and determining a defect based on a signal from a meander disposed on the one or more circuit board.

19. The inspection system of claim 16 wherein the second output signal is generated below a predetermined speed.

20. A method of inspecting a rail comprising:
generating a magnetic field in the rail from a magnetic circuit so that the magnetic field is aligned with a direction of motion along the rail;
generating first signals from magnetic sensors positioned between legs of the magnetic circuit;
directing laser beams to the rail;
generating transmitting coil signals from a first meander disposed at a first leg of the magnetic circuit;
generating receiving coil signals from a second meander; and
determining a defect in the rail based on the first signals and the receiving coil signals.
